(19) United States
(12) Patent Application Publication
(10) Pub. No.: US 2026/0035273 A1
(43) Pub. Date: Feb. 5, 2026

(54) METHODS FOR DEIONIZATION OF AN AQUEOUS FLUID

(71) Applicant: VOLTEA LIMITED, London (GB)

(72) Inventors: Kaustub SINGH, London (GB); Armin Johannes MICHEL, London (GB); Freddie KERPELS, London (GB); Louis Cornelia Patrick Maria DE SMET, London (GB)

(21) Appl. No.: 18/996,707

(22) PCT Filed: Jul. 20, 2023
(86) PCT No.: PCT/EP2023/070132

§ 371 Date: Jan. 17, 2025

(30) Foreign Application Priority Data
Jul. 20, 2022 (NL) 2032557

(51) Int. Cl. C02F 1/461; C02F 103/08

(52) U.S. Cl. CPC C02F 1/46109; C02F 2001/46133; C02F 2103/08; C02F 2201/46115; C02F 2303/16

(57) ABSTRACT

The invention relates to a method for removing ions from an aqueous fluid in an electrochemical cell, including directing an aqueous fluid through the electrochemical cell, thereby allowing contact between said aqueous fluid and a first electrode and second electrode; applying a current to the electrochemical cell, thereby forming a deionized aqueous fluid in the electrochemical cell; collecting the deionized aqueous fluid from the electrochemical cell; reverting the current, thereby at least partly regenerating said first electrode and said second electrode, and forming an aqueous fluid enriched in ions into the electrochemical cell; wherein the voltage in the electrochemical cell, is between −1.23 V and 1.23 V and wherein the ratio between the electric current divided by the total weight of the first electrode and the second electrode and the conductivity of the aqueous fluid, when entering the electrochemical cell, is at least 1 to 25 mA·cm/μS·g.

### FIELD OF THE INVENTION

The invention relates to methods for removing ions from an aqueous fluid in an electrochemical cell. The methods of the invention result in improved stability of the electrodes.

### INTRODUCTION

Capacitive deionization (CDI) is an electrochemical water desalination technique in which the anions and cations are removed from water and temporarily stored in capacitive electrodes by creating a potential difference between them. Conventionally, porous carbon has been used as an electrode material in CDI, due to its low cost, high specific surface area and electronic conductivity. Ion storage in these electrodes proceeds via an electrical double layer (EDL) formation on the pore surface. However, carbon electrodes in CDI suffer from co-ion expulsion i.e. the depletion of co-ions from the EDL during counter-ion adsorption. This results in only a partial use of the applied current or the potential difference in storing counter-ions in the micropores of the carbon electrodes, as the remaining part is diverted towards the removal of co-ions from the micropores. As a consequence, the energy and thermodynamic efficiency of the process decreases. It can be solved by placing ion-exchange membranes, IEMs, in between the electrodes and the flow channel, effectively blocking the release of the co-ions from the micropores. This is called membrane capacitive deionization, MCDI. Furthermore, the ion storage in the electrical double layers shows limited inherent selectivity towards different ions, restricting its use in selective ion-exchange membranes.

Recently, intercalation materials, explored in the field of batteries, have found application in electrode materials as an alternative to the porous carbon in CDI. The ion storage in these materials involves insertion of an ion, mostly cation, in interstitial sites. This mechanism is advantageous, as it has the desirable characteristics of adsorption similar to carbon such as fast kinetics and improves upon the ion storage capacity, while eliminating the co-ion repulsion. In addition, desalination systems based on intercalation materials provide more flexibility for selective removal of ions of choice without any chemical modifications of the electrode. Finally, the intercalation electrodes can store the same amount of charge at a lower voltage, which can lower their energy consumption in comparison to their carbon-based counterparts.

A disadvantage of intercalation materials is that they typically suffer from poor stability during use, resulting in degradation of the electrodes comprising such intercalation materials. This poor stability limits their use, since an electrochemical cell comprising one or more electrodes comprising an intercalation material must be replaced frequently, typically after only about 40-100 cycles of use. There is thus a need for methods for removing ions from an aqueous fluid in an electrochemical cell that result in improved stability of the electrodes.

### SUMMARY OF THE INVENTION

The inventors realized that the stability of electrodes comprising intercalating material can be markedly improved by selecting the operational parameters such that the difference in average voltage during the charging phase and the average voltage during the discharging phase is as low as possible. This may be achieved by selecting a ratio between the electric current divided by the total weight of the first electrode and the second electrode expressed as milliampere per gram of electrode (mA/g) and the conductivity of the aqueous fluid as a indicator for the concentration of ions, expressed in μS·/cm when entering the electrochemical cell, which ratio is to be at least 1 to 25. This ratio is expressed in mA·cm/μS·g. By operating the electrochemical cell under such conditions, it can be used for at least 100 cycles, typically at least about 1000 cycles, before degradation of the electrodes is observed. Accordingly, the invention relates to a method for removing ions from an aqueous fluid in an electrochemical cell, said electrochemical cell comprising a first compartment comprising a first electrode, said first electrode comprising a conductive material and an intercalation material, wherein said electrochemical cell further comprises a second electrode, and wherein said electrochemical cell is configured to allow propagation of a current, the method comprising: a) directing an aqueous fluid through the electrochemical cell, thereby allowing contact between said aqueous fluid and said first electrode and second electrode; b) applying a current to the electrochemical cell, thereby allowing intercalation of cations present in the aqueous fluid into the intercalation material of the first electrode, and allowing removal of anions from the aqueous fluid present in the first compartment; or allowing intercalation of anions present in the aqueous fluid into the intercalation material of the first electrode, and allowing removal of cations from the aqueous fluid present in the first compartment; thereby forming a deionized aqueous fluid in the first compartment of the electrochemical cell; c) collecting the deionized aqueous fluid from the first compartment of the electrochemical cell; d) reverting the current, thereby releasing cations and anions into the first compartment of the electrochemical cell, thereby at least partly regenerating said first electrode and said second electrode, and forming an aqueous fluid enriched in ions into the first compartment of the electrochemical cell; wherein the voltage in the electrochemical cell is between −1.23 V and 1.23 V and wherein the ratio between the electric current divided by the total weight of the first electrode and the electrode expressed as milliampere per gram of electrode (mA/g) and the conductivity of the aqueous fluid as a indicator for the concentration of ions, expressed in μS·/cm when entering the electrochemical cell, which ratio is to be at least 1 to 25. Said second electrode has an ability to remove ions from an aqueous fluid, which ions are of opposite charge compared to the ions intercalated by said first electrode, wherein in step b) said removal comprises insertion of said cations or anions into said second electrode; and wherein in step d) said releasing comprises either release of cations from said first electrode into the first compartment of the electrochemical cell and release of anions from said second electrode into the first compartment of the electrochemical cell; or release of anions from said first electrode into the first compartment of the electrochemical cell and release of cations from said second electrode into the first compartment of the electrochemical cell.

Said electrochemical cell may further comprise a second compartment comprising said second electrode, said first and second compartments being separated by an ion-exchange membrane, wherein in step b) said removal comprises allowing cations or anions present in the aqueous fluid in the first compartment to move into the aqueous fluid present in the second compartment of the electrochemical cell; and wherein in step d) said releasing comprises either release of cations from said first electrode into the first compartment of the electrochemical cell and allowing anions present in the aqueous fluid of the second compartment to move into the aqueous fluid of the first compartment of the electrochemical cell; or release of anions from said first electrode into the first compartment of the electrochemical cell and allowing cations present in the aqueous fluid of the second compartment to move into the aqueous fluid of the first compartment of the electrochemical cell.

Said first electrode and said second electrode may comprise an intercalation material that has an ability to intercalate cations, preferably wherein the intercalation material of said first electrode and said second electrode is the same, wherein, in step b) cations are allowed to intercalate into said first electrode and anions present in the aqueous fluid of the first compartment are allowed to move into the aqueous fluid present in the second compartment of the electrochemical cell, thereby forming an aqueous fluid enriched in ions in the second compartment of the electrochemical cell; and in step d) cations are released from said first electrode into the aqueous fluid present in the first compartment of the electrochemical cell and anions present in the aqueous fluid of the second compartment are allowed to move into the aqueous fluid of the first compartment of the electrochemical cell, thereby forming a deionized aqueous fluid in the second compartment of the electrochemical cell. Steps a) and c) can be performed simultaneously with steps b) and d).

In methods of the invention, the ratio between the electric current divided by the total weight of the first electrode and the second electrode and the conductivity of the aqueous fluid, when entering the electrochemical cell, preferably is between 1 to30 and 1 to 75 mA·cm/μS·g.

The ratio can be calculated by taking the total weight of the first electrode and the second electrode by weighing. Alternatively the weight of the uncoated electrode can be weighed separately or calculated based on the surface area, thickness and material density of the two electrodes. The weight of electrode coating can be determined by weighing the coating composition prior to application to the electrode, without any solvents or by calculating the weight of the coating the applied coating (surface of the electrode * thickness of electrode * density of coating composition). The conductivity can be determined by a, preferably calibrated, conductivity meter and can be estimated from the electrolyte concentration. This leads to the ratio equation:

$$Current / ( Conductivity * weight ) in$$

$$mA / ( μS / cm ) * g or ( mA * Cm ) / ( μS * g ) )$$

In methods of the invention, the current in step b) may be applied for between 1 and 60 minutes, preferably between 3 and 30 minutes, more preferably between 4 and 8 minutes, and/or the current is reverted in step d) for between 1 and 30 minutes, preferably between 3 and 30 minutes, more preferably between 4 and 8 minutes.

In methods of the invention, the difference between the average voltage in the electrochemical cell during step b) and the average voltage in the electrochemical cell during step d) is between 0.1 and 0.5 V, preferably between 0.2 and 0.4 V, more preferably around 0.3 V.

In methods of the invention, the current in step b) is between 5 mA/g and 75 mA/g, preferably between 25 mA/g and 55 mA/g and/or wherein in step d) the current is between −5 mA/g and −75 mA/g, preferably between −25 mA/g and −55 mA/g.

The concentration of the ions in the aqueous fluid is related to the conductivity. A higher concentration of ions generally increases conductivity, depending on the presence of weak or strong electrolytes. The relation may be linear within normal concentration ranges, but the reaction can be confirmed by conductivity measurements with a (calibrated) conductivity meter. For a strong electrolyte, such as sodium chloride. the relation is more or less linear. As for a feed, typically the exact concentration of ions and type of ions are not known, conductivity is a reliable parameter as an indicator of the ion concentration.

In methods of the invention, the conductivity and/or the concentration of ions in the aqueous fluid, when entering the electrochemical cell, is between about 100 μS·/cm and about 100.000 μS·/cm, preferably between about 500 μS·/cm and about 10.000 μS·/cm, more preferably between about 1000 μS·/cm and about 5000 μS·/cm.

In methods of the invention, the aqueous fluid is directed at a flow rate of between about 3 and about 10 ml/min·cm2, preferably between about 4 and about 8 ml/min·cm2.

In methods of the invention, the intercalation material is selected from Prussian Blue, a Prussian Blue analogue, Na0.44MnO2, lambda-MnO2, gamma-MnO2, delta-MnO2, Na2FeP2O7, Na3V2(PO4)3, NaVPO4F, NaCo⅓Ni⅓Mn⅓PO4, olivine LiMePO4, NaTi2(PO4)3 and vanadium oxides, preferably wherein the intercalation material comprises a Prussian Blue Analogue material, more preferably nickel hexacyanoferrate or copper hexacyanoferrate.

In methods of the invention, at least one electrode, preferably both electrodes, may comprise −70-90 wt. % of an intercalation material, preferably nickel cyanoferrate; −0-10 wt. % of a binder; and 5-20 wt. % of a conduction material, preferably carbon, with the proviso that the total of intercalation material, binder and conduction material is between 95 wt. % and 100 wt. %, more preferably between 97 wt. % and 100 wt. %, even more preferably between 99 wt. % and 100 wt. %.

In methods of the invention, steps b) and d) may be repeated, preferably at least 100 times, more preferably at least 500 times, even more preferably at least 1000 times.

### BRIEF DESCRIPTION OF THE FIGURES

FIG. 1: General set-up of an electrochemical cell for use in a preferred method according to the invention. The electrochemical cell (1) comprises a first compartment (2) comprising a first electrode (3) and a second compartment (4), comprising a second electrode (5), said first (2) and second (4) compartments being separated by an anion-exchange membrane (AEM). Said first electrode (3) and said second electrode (5) each comprise an intercalation material (6), preferably a Prussian Blue Analogue, more preferably nickel hexacyanoferrate, and a conductive material, preferably conductive carbon. In said first (2) and second (4) compartments inlets for an aqueous feed solution (7a, 7b) are present. Said inlets are typically connected to means (8) for promoting the flow of said aqueous solution through said first (2) and said second (4) compartments, such as a mechanical pump.

During use, contact between said aqueous fluid and said first and said second electrodes is ensured, to allow intercalation and release of cations into/from the electrodes.

Said electrochemical cell (1) further comprises outlets (9a, 9b) into an upper part of the electrochemical cell for withdrawing an aqueous fluid enriched in ions or a deionized aqueous fluid from the electrochemical cell.

Said electrochemical cell (1) further typically comprises a power supply (10) connected to the first and second electrodes to form an electrical circuit.

During use, a current is applied (also referred to as ‘charging phase’) onto the electrochemical cell, resulting in release of electrons into the conductive material of the first electrode (3) and release of cations from the intercalation material of the second electrode (5) into the aqueous solution present in the second compartment (4) of the electrochemical cell (1). This release of cations causes a difference in charge between the aqueous fluids present in the first compartment (2) and second compartment (4) of the electrochemical cell (1) thereby promoting the transport of anions present in the aqueous fluid of the first compartment through the anion-exchange membrane into the aqueous fluid present in the second compartment (4) of the electrochemical cell (1). Similarly, electrons are released into the intercalation material of the first electrode (3), promoting intercalation of cations present in the aqueous fluid of the first compartment (2) into the intercalation material of the first electrode (3). These processes result in the formation of an aqueous fluid enriched in ions in the second compartment (4) of the electrochemical cell, and a deionized aqueous fluid present in the first compartment (2) of the electrochemical cell. During the charging phase, the first electrode (3) is positively charged and the second electrode (5) is negatively charged.

After completion of the charging phase, the current is reverted (also referred to as “discharging phase”). By reverting the current, the first electrode (3), which was positively charged during the charging phase, becomes the negative electrode and the second electrode (5), which was negatively charged during the charging phase, becomes the positive electrode. By reverting the charges on the first and second electrodes, cations intercalated into the first electrode (3) during the charging phase are released into the aqueous fluid of the first compartment (2), thereby promoting transport of anions present in the second compartment (4) to move to the first compartment (2) and intercalation of cations present in the aqueous fluid of the second compartment (4) into the intercalation material of the second electrode (5). Hence, an aqueous fluid enriched in ions is formed in the first compartment (2) of the electrochemical cell (1) and a deionized aqueous fluid is formed in the second compartment (4) of the electrochemical cell (1).

During use, said aqueous fluid enriched in ions and said deionized aqueous fluid may be withdrawn from the electrochemical cell (1) via outlets (9a, 9b) present in the first compartment (2) and second compartment (4) of the electrochemical cell (1). Typically, the outlets (9a, b) are connected via a conduit to a reservoir for collecting an aqueous fluid enriched in ions (not shown) and a reservoir for collecting a deionized aqueous fluid (not shown). As the skilled person will understand from the above, the direction of the current decides whether the aqueous fluid enriched in ions and the deionized aqueous fluid are formed in the first compartment (2) or second compartment (4) of the electrochemical cell (1).

Hence, the reservoirs for collecting the aqueous fluid enriched in ions and the deionized aqueous fluid are switched after completion of the charging phase.

FIG. 2. Current-Voltage (I-V) data for desalination cycles 1-35. (A) Echarge and EDischarge are the cell voltages recorded when the applied current was greater and smaller than 0 mA, respectively. For analysis over cycle, the every Echarge and EDischarge values were time averaged over each cycle to give one value of <Echarge> and <EDischarge> per cycle. The difference between these two averages, <Echarge>-<EDischarge> is the difference in cell voltage, ΔE. (B) Graphical demonstration of Echarge, EDischarge, and ΔE for the IV data recorded for desalination cycles 1-34 in (A).

FIG. 3. Concentration of the effluent out of the two channels during desalination cycles 1-35.

FIG. 4. IV data recorded during the concluding 100 cycles of desalination.

FIG. 5. Graphical demonstration of Echarge, EDischarge, and ΔE for the IV data recorded for desalination cycles 1310-1410.

FIG. 6. Concentration of the effluent out of the two channels during desalination cycles 1310-1410.

FIG. 7. The ΔE values for various number of cycles, taken at different times during the overall desalination experiments.

FIG. 8: IV profile obtained during 50 cycles of desalination of a 4 mM feed by a 13 mA current.

### DEFINITIONS

The term “or” as used herein is defined as “and/or” unless specified otherwise.

The term “a” or “an” as used herein is defined as “at least one” unless specified otherwise.

When referring to a noun (e.g. a compound, an additive, etc.) in the singular, the plural is meant to be included.

The term “(at least) substantial(ly)” is generally used herein to indicate that it has the general character or function of that which is specified. When referring to a quantifiable feature, this term is in particular used to indicate that it is at least 50%, more in particular more than 75%, even more in particular more than 90% of the maximum that feature. The term ‘essentially free’ is generally used herein to indicate that a substance is not present (below the detection limit achievable with analytical technology as available on the effective filing date) or present in such a low amount that it does not significantly affect the property of the product that is essentially free of said substance. In practice, in quantitative terms, a product is usually considered essentially free of a substance, if the content of the substance is 0-1 wt. %, in particular 0-0.5 wt. %, more in particular 0-0.1 wt. %.

In the context of this application, the term “about” means generally a deviation of 15% or less from a given value, in particular a deviation of 10% or less, preferably a deviation of 5% or less.

The skilled person is familiar with the term “near”. Generally, this term is read in relation to another term, and the skilled person will be able to reduce implementation thereof to practice, based on common general knowledge, the information and citations disclosed herein, and the specifics of the electrochemical cell.

As a rule of thumb, unless follows differently from the context, ‘near’ a certain reference point usually means that the distance between the relevant point (such as an inlet) and the reference point (such as a base of an electrode) is less than 20% from the total distance, preferably less than 15%, more preferably less than 10%, in particular less than 5% of the total distance, wherein the total distance is the largest dimension of the electrochemical cell.

The term “fluid”, as used herein refers to a liquid, or mixture of liquids, whereby said liquid or mixture of liquids optionally comprises another phase such as a gas or a solid (suspension), that is capable of flowing through an electrochemical cell, without requiring to apply an external pressure other than gravity. A fluid typically has a density in a range that it cannot hold its own shape in absence of a support, such as the walls of the electrochemical cell or a container.

With the term “deionized aqueous fluid” as used herein, is meant an aqueous fluid that has a lower conductivity than the conductivity of an aqueous fluid entering the cell. This can be determined by measuring the conductivity of the aqueous fluid, when entering the cell, and the conductivity of the aqueous fluid, collected from the electrochemical cell, after the method according to the invention has been performed.

With the term “aqueous fluid enriched in ions” as used herein, is meant an aqueous fluid that has a higher conductivity than the conductivity of an aqueous fluid entering the cell. This can be determined by measuring the conductivity of the aqueous fluid, when entering the cell, and the conductivity of the aqueous fluid, collected from the electrochemical cell, after the method according to the invention has been performed.

The conductivity can be measured using a conductivity meter, such as the Orion™ Versa Star Pro™ Conductivity Benchtop Meter, commercially available from Thermo Scientific™.

With the term “cycle” is meant herein, a sequence of step b) and step d) of the method according to the invention. Accordingly, a “half cycle” refers to the performance of only step b) or step d). A method according to the invention can be performed for multiple cycles, meaning that steps b) and d) are repeated a number of times.

In the context of the present application, the term “intercalation” refers to the reversible insertion of an ion into a two-dimensional or three-dimensional structure, typically the crystal lattice of an intercalation material.

Herein, an “intercalation material” refers to a material that is capable of reversibly extracting ions from an aqueous solution. Examples of intercalation materials include MXene, Na_{0.44}MnO₂, lambda-MnO₂, gamma-MnO₂, delta-MnO₂, Na₂FeP₂O₇, Na₃V₂(PO₄)₃, NaVPO₄F, NaCo_{1/3}Ni_{1/3}Mn_{1/3}PO₄, olivine LiMePO₄, NaTi₂(PO₄)₃, vanadium oxides and Prussian Blue and analogues thereof. “Prussian Blue” and “Prussian Blue Analogues” constitute a class of cation-intercalating materials having the chemical formula A₂M[Fe(CN)₆]·nH₂O, wherein “A” represents an alkali metal ion and wherein “M” represents a transition metal, i.e. an element from any one of groups 3 to 12 from the periodic table. When referring to the term Prussian Blue, “M” is iron (Fe). In Prussian Blue Analogues, “M” is a transition metal other than iron. Examples of transition metals present in a Prussian Blue Analogue include nickel (Ni), manganese (Mn), cobalt (Co), copper (Cu), vanadium (V), chromium (Cr), and zinc (Zn).

Prussian Blue and Prussian Blue Analogues have an open-framework crystal structure containing large interstitial sites that allow for the reversible insertion of a variety of cations, including Li⁺, Na⁺, K⁺, Mg²⁺, Ca²⁺, Zn²⁺, Al²⁺ and NH₄⁺. Upon intercalation of a cation, the iron centre is reduced from oxidation state Fe^{(III)} to Fe^{(II)}, whereas during release of an cation, the iron centre is oxidized from Fe^{(II)} to Fe^{(III)}. This reversible intercalation is described with half reactions 1 and 2:

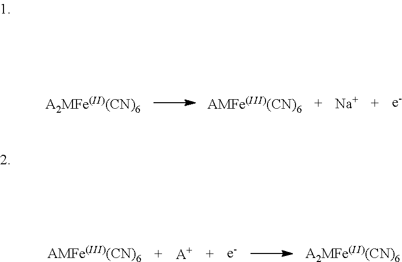

The ability of Prussian Blue and their analogues to temporality store cations into their crystal lattice makes them particularly suitable for energy storage, such as in battery applications and in electrochemical cells. Prussian Blue and their analogues are well defined in the literature, for example in Matos-Peralta et al. 2020. J Electrochem Soc 167: 037510, and in Li et al., 2020. Advanced Science 7: 2002213.

“MXene” as used herein, refer to metal carbides and nitrides that structurally originate from MAX phases. MXenes form two-dimensional sheets that has an ability of intercalating ions via faradaic ion intercalation between two-dimensional sheets of MXene.

As used herein “MAX” refers to a large group of ternary transition metal carbides and nitrides with the formula Mₙ₊₁AXₙ, wherein n=1, 2 or 3 and M is an transition metal from any one of groups 3 to 7 of the periodic table, “A” is a material selected from Boron (B), Aluminium (Aal), gallium (Ga), Indium (In), Thallium (TI), Nihonium (Nh), Carbon (C), Silicium (Si), Germanium (Ge), Tin (Sn), Lead (Pb) and Flerovium (FI) and X is C and/or N. An example of a MAX is Ti₃AlC₂.

MXenes are well defined in the literature, for example in Srimuk et al. 2016. J. Mater. Chem. A. 4:18265.

The term “average”, as is used herein, refers to the arithmetic mean.

For the purpose of clarity and a concise description features are described herein as part of the same or separate embodiments, however, it will be appreciated that the scope of the invention may include embodiments having combinations of all or some of the features described.

### DETAILED DESCRIPTION

Methods for Removing Ions from an Aqueous Fluid

The inventors realized that the stability of electrodes comprising an intercalation material can be markedly improved by operating the electrochemical cells under conditions wherein the difference between the average voltage in the electrochemical cell during the charging phase and the average voltage in the electrochemical cell during the discharging phase (delta E) is as low as possible. The inventors realized that the ratio between the current and feed concentration (measurable as conductivity) is one of the most relevant factors for obtaining a low delta E and thus a good stability of the electrodes.

It was found that this low difference in average voltage between the charging phase (step b) and the discharging phase (step d) can be practically achieved by fixing the ratio between the electric current divided by the total weight of the first electrode and the second electrode expressed as milliampere per gram of electrode (mA/g) and the conductivity of the aqueous fluid as a indicator for the concentration of ions, expressed in μS·/cm when entering the electrochemical cell, which ratio is to be at least 1 to 25. g, preferably at least 1 to 30 pS·g/mA·cm, more preferably at least 1 to: 40 pS·g/mA·cm, even more preferably at least 1 to: 50 pS·g/mA·cm.

Without wishing to be bound by any theory, it is believed that at such a ratio between conductivity and electric current, the ion intercalation rate into the intercalation material of the first electrode, and—if present—into the intercalation material of the second electrode, is optimal, thereby preventing degradation of the first electrode and optionally the second electrode. Such degradation typically leads to an increased resistance in the electrode, which is reflected in an increase in difference in average voltage during the charging and discharging phase.

Accordingly, the invention relates to a method for removing ions from an aqueous fluid in an electrochemical cell, said electrochemical cell comprising a first compartment comprising a first electrode, said first electrode comprising a conductive material and an intercalation material, wherein said electrochemical cell further comprises a second electrode, and wherein said electrochemical cell is configured to allow propagation of a current, the method comprising:
a) directing an aqueous fluid through the electrochemical cell, thereby allowing contact between said aqueous fluid and said first electrode and second electrode;
b) applying a current to the electrochemical cell, thereby
allowing intercalation of cations present in the aqueous fluid into the intercalation material of the first electrode, and allowing removal of anions from the aqueous fluid present in the first compartment; or
allowing intercalation of anions present in the aqueous fluid into the intercalation material of the first electrode, and allowing removal of cations from the aqueous fluid present in the first compartment;
thereby forming a deionized aqueous fluid in the first compartment of the electrochemical cell;
c) collecting the deionized aqueous fluid from the first compartment of the electrochemical cell;
d) reverting the current, thereby releasing said cations and anions into the first compartment of the electrochemical cell, thereby at least partly regenerating said first electrode and said second electrode, and forming an aqueous fluid enriched in ions into the first compartment of the electrochemical cell;
wherein the voltage in the electrochemical cell, is between −1.23 V and 1.23 V and wherein the ratio between the electric current divided by the total weight of the first electrode and the second electrode and the conductivity of the aqueous fluid, when entering the electrochemical cell, is at least 1:25 mA·cm/μS·g.

Preferably, the ratio between the electric current divided by the total weight of the first electrode and the second electrode and the conductivity of the aqueous fluid, when entering the electrochemical cell, is between about 1:25 mA·cm/μS·g and about 1:250 mA·cm/μS·g, more preferably between about 1:30 mA·cm/μS·g and about 1:175 mA·cm/μS·g, even more preferably between about 1:35 mA·cm/μS·g and about 1:100 mA·cm/μS·g, in particular between about 1:40 mA·cm/μS·g and about 1:75 mA·cm/μS·g.

In a method according to the invention, the voltage in the electrochemical cell is between −1.23 V and 1.23 V. This voltage window is selected to avoid splitting of water in the electrochemical cell to form O₂ and H₂. The occurrence of water splitting during a method according to the invention is undesired, because it leads to a loss of product (deionized water) and is not energetically favorable. Further, the formation of gas during the process may disturb the removal of ions from an aqueous solution, and may damage the electrochemical cell.

In preferred embodiments of the invention, the voltage in the electrochemical cell is between −1.1 V and 1.1 V, preferably between −1.05 and 1.05, more preferably between −1.0 and 1.0, −0.9 and 0.9, −0.8 and 0.8, or −0.7 and 0.7.

The invention preferably relates to a method wherein the difference between the average voltage in the electrochemical cell during step b) and the average voltage in the electrochemical cell during step d) is between 0.1 and 0.5 V, preferably between 0.2 and 0.4 V, more preferably around 0.3 V. At such difference in average voltage during step b) and average voltage during step d), the stability of the first electrode and second electrode was excellent. At such a difference in average voltages, the method according to the invention could be performed for at least 40 times, preferably at least 50 times, at least 100 times, at least 500 times, at least 700 times, at least 900 times, most preferably at least 1200 times, without observing any degradation of the electrodes.

The skilled person is capable of determining the average voltage during step b) and/or step d) of a method according to the invention. The average value of the voltage may be calculated by taking a mean of all voltage data points collected at every time step at which the data was obtained. As the skilled person understands, the average voltage during step b) is determined by measuring the voltage at a plurality of time points, for example, every second, taking the sum of the obtained data points and dividing the sum by the total number of data points. This provides the average voltage during step b) (E_{charge}). Similarly, the average voltage during step d) is determined to provide the average voltage during step d) (E_{dhscharge}). The difference (ΔE) may be obtained using the formula ΔE=E_{charge}−E_{discharge}.

### Electrochemical Cell

In a method according to the invention, an electrochemical cell comprises a first compartment comprising a first electrode, said first electrode comprising a conductive material and an intercalation material, wherein said electrochemical cell further comprises a second electrode, and wherein said electrochemical cell is configured to allow propagation of a current.

Said electrochemical cell may have any shape, size or dimensions. Preferably, said electrical cell is in the shape of a cube or a rectangular cuboid. The dimensions of the electrochemical cell may be in the range of between about 1 and 10.000 cm³, such as between 5 and about 100 cm³, more preferably between about 7 and about 75 cm³, most preferably between about 10 and about 30 cm³. It is noted that normalization takes into account especially active areas of the electrode and membrane since the ions always travel in the direction perpendicular to the direction of the flow. In addition, the resistance is the system is related to the active area as well. Therefore, the exact volume of the cell may be less relevant, when compared to the active areas of the electrodes and membranes, and by extension, the cell.

In a method according to the invention, one electrochemical cell may be used, a series of electrochemical cells (also referred to in the art as a stack), or even multiple stacks of electrochemical cells (also referred to in the art as a module).

Stacks and modules of electrochemical cells are typically configured such that deionized fluid from one electrochemical cell is allowed to enter a second electrochemical cell, thereby allowing multiple cycles of deionization.

### Electrodes

Said electrochemical cell comprises a first compartment comprising a first electrode comprising an intercalation material and a conductive material and further comprises a second electrode. Said intercalation material has an ability of intercalating either cations or anions from an aqueous fluid.

Preferably, said first electrode and/or said second electrode comprises an intercalation material that has an ability of intercalating cations from an aqueous solution.

Examples of intercalation materials that have an ability to intercalate cations include Prussian Blue, a Prussian Blue analogue, Na_{0.44}MnO₂, lambda-MnO₂, gamma-MnO₂, delta-MnO₂, Na₂FeP₂O₇, Na₃V₂(PO₄)₃, NaVPO₄F, NaCo_{1/3}Ni_{1/3}Mn_{1/3}PO₄, olivine LiMePO₄, NaTi₂(PO₄)₃ and vanadium oxides.

Accordingly, in a method according to the invention, said first electrode and/or said second electrode preferably comprises an intercalation material selected from the group consisting of Prussian Blue, a Prussian Blue analogue, Na_{0.44}MnO₂, lambda-MnO₂, gamma-MnO₂, delta-MnO₂, Na₂FeP₂O₇, Na₃V₂(PO₄)₃, NaVPO₄F, NaCo_{1/3}Ni_{1/3}Mn_{1/3}PO₄, olivine LiMePO₄, NaTi₂(PO₄)₃ and vanadium oxides, more preferably Prussian Blue or a Prussian Blue analogue, even more preferably nickel hexacyanoferrate or copper hexacyanoferrate.

Alternatively, at least one of said first or said second electrode may have an ability of intercalating anions from an aqueous.

An example of an intercalation material that has an ability of intercalating anions are materials comprising two-dimensional nanolayered structures. A preferred example of such a material is MXene. Such electrodes are described in literature, see for example Srimuk et al. 2016. J Material Chem A, 4: 18265.

Optionally, one of said first electrode and said second electrode may comprise a material that is non-intercalating. Examples of suitable materials include porous carbon electrodes or electrodes comprising metals, such as platinum, silver or titanium electrodes.

The intercalation capacity of the first electrode and/or said second electrode typically ranges between about 30 mAh/g and about 200 mAh/g, depending on the type of intercalation material that is used. As the skilled person is aware, the intercalation capacity is an inherent property of the intercalation material and reflects the total of ions that may be intercalated in an intercalation material per gram of electrode, or per gram of intercalation material, as is known to a person skilled in the art.

Preferably, the intercalation capacity of the first electrode and/or the second electrode is between about 30 and about 200 mAh/g, more preferably between about 35 and about 150 mAh/g, even more preferably between about 38 mAh and about 100 mAh/g, most preferably between about 40 and about 70 mAh/g.

It is particularly preferred that the intercalation capacity of said first and said second electrodes are essentially the same.

Preferably, the difference in intercalation capacity between said first electrode and said second electrode is not more than +/−20 mAh/g, more preferably not more than +/−15 mAh/g, even more preferably not more than +/−10 mAh/g, in particular not more than +/−5 mAh/g.

Preferably, the ratio between the intercalation capacity of the first electrode and the second electrode is between 1:2 and 2:1, more preferably between 1:1.5 and 1.5:1, even more preferably between about 1:1.2 and about 1.2:1, in particular between about 1:1.1 and about 1.1:1., most preferably about 1:1.

In said first electrode and/or said second electrode, said intercalation material is preferably present in an amount of at least 70 wt. %, based on the total weight of the first electrode, more preferably in an amount of at least 75 wt. %, at least 80 wt. %, at least 85 wt. %, most preferably at least 90 wt. % of the total weight of the first electrode or the second electrode.

Preferably, said intercalation material is present in a range of between about 70 wt. % and about 90 wt. %, more preferably between 75 wt. % and 85 wt. %, in particular between about 78 wt. % and about 83 wt. %, based on the total weight of said first electrode or said second electrode.

Said first electrode and/or said second electrode further comprises a conductive material. In principle, any conductive material may be used that is suitable for conducting an electric current through said electrochemical cell. Said conductive material preferably has high electronic conductivity, chemical inertness and reduced or no salt adsorption capacity. The latter is preferred to allow only one adsorption element in an electrode.

Examples of suitable conductive materials for use according to the invention include conductive carbon black, conductive metals such as gold and copper. Preferably, said conductive material comprises conductive carbon black.

In said first electrode and/or said second electrode, said conductive material is preferably present in an amount of at least 5 wt. %, based on the total weight of the first electrode or said second electrode, more preferably in an amount of at least 7 wt. %, at least 10 wt. %, at least 15 wt. %, most preferably at least 20 wt. % of the total weight of the first electrode or said second electrode.

Preferably, said conductive material is present in a range of between about 5 wt. % and about 20 wt. %, more preferably between 7 wt. % and 18 wt. %, in particular between about 10 wt. % and about 15 wt. %, based on the total weight of said first electrode or said second electrode.

Said first electrode and/or said second electrode optionally further comprises one or more binders. A binder is a material that promotes contact between said conductive material and said intercalation material and for providing shape to said first electrode or second electrode.

Examples of suitable binders include polymers such as include poly-tetra-fluoroethylene (PTFE) and polyvinylidene fluoride (PVDF). Preferably, said binder comprising PTFE.

In said first electrode and/or said second electrode, said binder is preferably present in an amount of at least 2 wt. %, based on the total weight of the first electrode or said second electrode, more preferably in an amount of at least 5 wt. %, at least 7 wt. %, at least 10 wt. % of the total weight of the first electrode or the second electrode.

Preferably, said binder is present in a range of between about 0 wt. % and about 10 wt. %, more preferably between 3 wt. % and 8 wt. %, in particular between about 5 wt. % and about 7 wt. %, based on the total weight of said first electrode or said second electrode.

Said first electrode and/or said second electrode is preferably essentially free of other components other than said intercalation material, said conductive material and said binder. Preferably, the total of said intercalation material, conductive material and binder is at least 95 wt. %, based on the total weight of said first electrode, more preferably at least 96 wt. %, at least 97 wt. %, at least 98 wt. %, at least 99 wt. %, most preferably 100 wt. %.

In an exemplary embodiment, said first electrode and/or said second electrode preferably comprises
70-90 wt. % of an intercalation material, preferably nickel hexacyanoferrate;
0-10 wt. % of a binder; and
5-20 wt. % of a conduction material, preferably carbon, with the proviso that the total of intercalation material, binder and conduction material is between 95 wt. % and 100 wt. %, more preferably between 97 wt. % and 100 wt. %, even more preferably between 99 wt. % and 100 wt. %.

Said first electrode and/or said second electrode may be prepared using any suitable methods known in the art for preparing electrodes comprising intercalation material. For example, said first electrode may be obtained by blending a powder of said intercalation material and said conductive material together to obtain a mixture of said intercalation material and said conductive material. Subsequently, said mixture is mixed with a dispersion of binder in a suitable liquid carrier, such as ethanol, to obtain a slurry of intercalation material, conductive material and binder. Said slurry of said intercalation material, said conductive material and optionally said binder is then kneaded to form a wet dough. Said wet dough is rolled to form a sheet and subsequently cut into a desired shape, and dried at a temperature of about 60° C. to remove residual liquid carrier.

Preferably, said first electrode and/or said second electrode is prepared by milling said intercalation material and said conductive material to obtain a mixture of intercalation material and conductive material. It was found that by milling the intercalation material and conductive material, an electrode may be obtained with good stability.

Milling of said intercalation material and conductive material may be achieved using a bead mill, for example a bead mill such as a Planetary Ball Mill PM 200 from Retsch (Haan, Germany).

A suitable method for preparing an electrode comprising an intercalation material and a conductive material are described in Singh et al., 2020. Desalination, 496: 114647.

Preferably, said first electrode and/or said second electrode has a mean particle size of between about 0.5 μm and about 5 μm, more preferably between about 1 μm and about 4 μm, even more preferably between about 2 μm and about 3 μm. The mean particle size may be calculated by dividing the sum of all particle sizes by the total number of particles. Herein, particle size may be determined using any suitable technique known in the art, such as microscopy (e.g. using an optical microscope, scanning electron microscope or transmission electron microscope), sieving gravitational sedimentation and light scattering.

Preferably, said first electrode and/or said second electrode is a porous electrode. A porous electrode enhances the contact between the intercalation material of the electrode and the aqueous fluid, thereby promoting intercalation of cations from the aqueous fluid into the intercalation material of the first electrode and/or the second electrode, or release of cations from the intercalation material present in the first electrode and/or the second electrode into the aqueous fluid.

Said first electrode and said second electrode may have an ability of removing ions of the same charge from an aqueous solution, or may have an ability of removing ions of opposite charge from an aqueous solution.

In an embodiment, said second electrode has an ability to remove ions from an aqueous fluid, wherein the ions that are removed by said second electrode are of opposite charge as the ions intercalated by said first electrode.

In such a method according to the invention, both cations and anions are removed from the aqueous fluid present in the first compartment of the electrochemical cell, thereby forming a deionized aqueous fluid.

Accordingly, the invention preferably relates to a method, wherein said second electrode has an ability of removing ions from an aqueous fluid that are of opposite charge as the ions intercalated by said first electrode,
wherein in step b) said removal comprises extraction of said cations or anions into said second electrode; and
wherein in step d) said releasing comprises either release of cations from said first electrode into the first compartment of the electrochemical cell and release of anions from said second electrode into the first compartment of the electrochemical cell or release of anions from said first electrode into the first compartment of the electrochemical cell and release of cations from said second electrode into the first compartment of the electrochemical cell.

Examples of electrochemical cells that are suitable for use in a preferred method according to the invention include flow-by capacitive deionization cells, membrane capacitive deionization cells, inverted capacitive deionization cells and hybrid capacitive deionization cells. Such cells are described in more detail by Tang et al. 2010. Water research 150:225.

### Second Compartment

In a further preferred method according to the invention, said electrochemical cell further comprises a second compartment comprising said second electrode, said first and second compartments being separated by an ion-exchange membrane.

The presence of a first compartment and a second compartment in an electrochemical cell advantageously allows the continuous formation of a deionized aqueous fluid without requiring having to stop the electrochemical cell during (partial) regeneration of the electrodes. This makes the method more efficient, and more attractive from an economical perspective.

Accordingly, the invention further preferably relates to a method according to the invention, wherein said electrochemical cell further comprises a second compartment comprising said second electrode, said first and second compartments being separated by an ion-exchange membrane,
wherein in step b) said removal comprises allowing cations or anions present in the aqueous fluid in the first compartment to move into the aqueous fluid present in the second compartment of the electrochemical cell; and
wherein in step d) said releasing comprises either release of cations from said first electrode into the first compartment of the electrochemical cell and allowing anions present in the aqueous fluid of the second compartment to move into the aqueous fluid of the first compartment of the electrochemical cell, or release of anions from said first electrode into the first compartment of the electrochemical cell and allowing cations present in the aqueous fluid of the second compartment to move into the aqueous fluid of the first compartment of the electrochemical cell.

Herein, said second electrode may have an ability to remove ions that are of opposite charge as the ions that are intercalated into the first electrode, but preferably has an ability of removing ions that are of the same charge as the ions that are intercalated into the first electrode.

If said second electrode has an ability to remove ions that are of opposite charge as the ions that are intercalated into the first electrode, then:
in step b), anions or cations present in the first compartment are allowed to move into the aqueous fluid present in the second compartment of the electrochemical cell, wherein said cations or anions are extracted from the aqueous fluid into the second electrode, thereby forming a deionized aqueous fluid in the second compartment of the electrochemical cell.
in step d), anions or cations are released from the first electrode into the first compartment and from the second electrode the second compartment of the electrochemical cell.

Herein, said second electrode preferably has an ability of removing anions from an aqueous solution. Examples of such second electrodes have been described herein above, and include carbon electrodes, electrodes comprising metals, such as platinum, silver or titanium electrodes, or electrodes comprising layered materials, preferably MXene.

If said second electrode has an ability to remove ions that are of the same charge as the ions that are intercalated into the first electrode, then:
in step b), anions or cations present in the first compartment are allowed to move into the aqueous fluid present in the second compartment of the electrochemical cell, thereby forming an aqueous fluid enriched in ions in the second compartment of the electrochemical cell;
in step d), anions or cations are released from the first electrode into the aqueous fluid present in the first compartment of the electrochemical cell, and anions or cations present in an aqueous fluid of the second compartment of the electrochemical cell are allowed to move into the aqueous fluid present in the first compartment of the electrochemical cell, thereby forming a deionized aqueous fluid in the second compartment of the electrochemical cell.

As the skilled person understands, in a method according to the invention, the charge of ions that are intercalated into the intercalation material of said first electrode defines that the charge of the ions that are allowed to move in step b) from said first compartment to said second compartment is of opposite charge and that the ions that are released in step d) are of the same charge. As is known, the movement of ions as defined in step b) of the method according to the invention is a consequence of a charge-imbalance created between said first compartment and said second compartment due to intercalation of ions of one charge into an intercalation material.

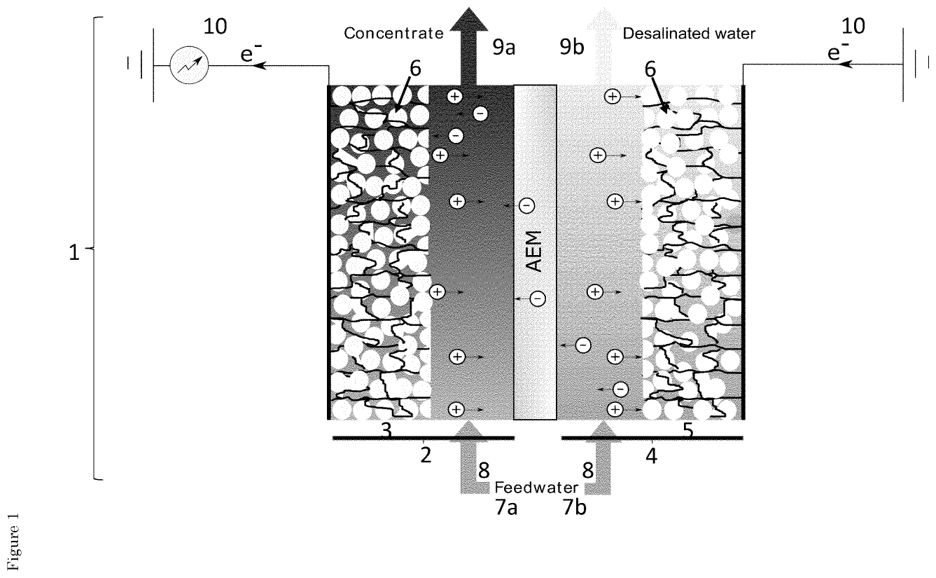

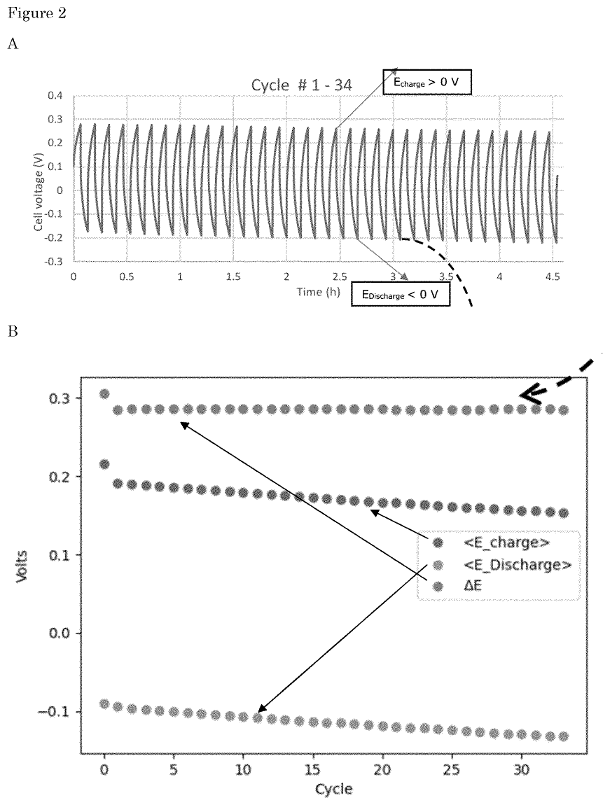

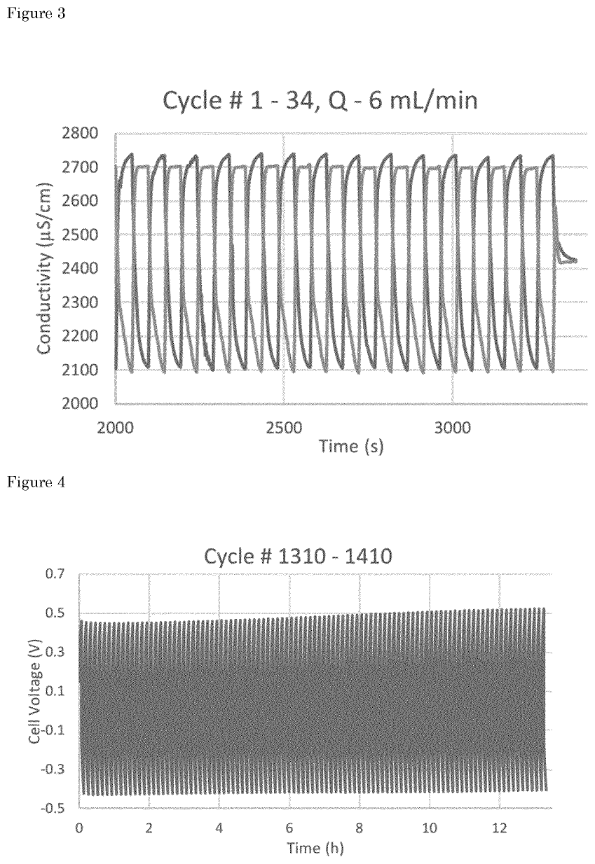

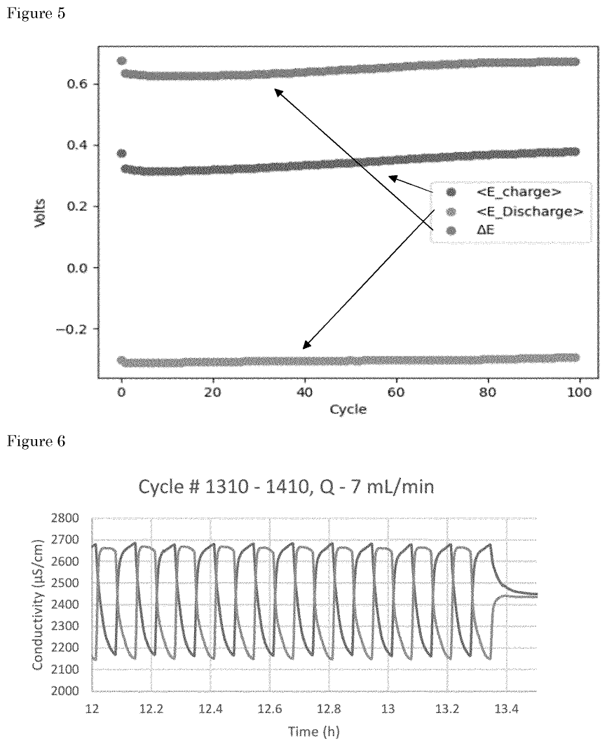

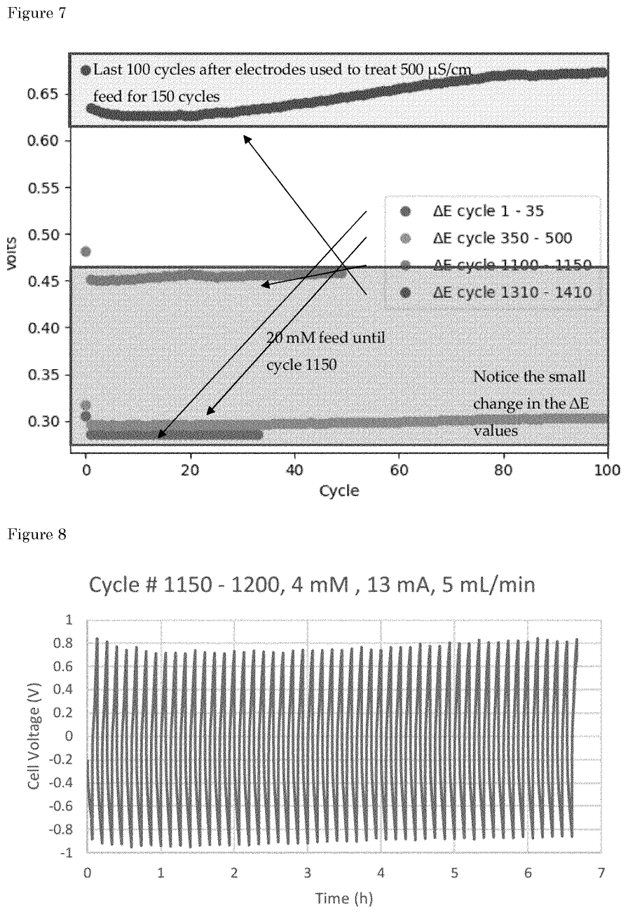

Preferably, said second electrode has an ability of removing ions from an aqueous fluid that are of the same charge as the ions that are intercalated by the first electrode. In such a method according to the invention, the electrochemical cell is referred to as a “symmetrical” cell. In a symmetrical cell, a deionized aqueous fluid may advantageously be produced continuously, e.g. during step b) a deionized aqueous fluid is formed in said first compartment and during step d) a deionized aqueous fluid may be formed in said second compartment. Continuous production of a deionized aqueous fluid is desired from an economical and a efficiency perspective, because it allows the production of a larger amount of deionized aqueous fluid per unit of time compared to using a method comprising in a non-symmetrical cell, at identical conditions. An example of a symmetrical cell is shown in FIG. 1.

Accordingly, the invention further relates to a method for removing ions from an aqueous in a symmetrical cell, wherein steps a) and c) are performed simultaneously with steps b) and d).

Accordingly, in a preferred method according to the invention, said first electrode and said second electrode comprise an intercalation material that has an ability to intercalate cations, thereby
in step b) cations are allowed to intercalate into said first electrode and anions present in the aqueous fluid of the first compartment are allowed to move into the aqueous fluid present in the second compartment of the electrochemical cell, thereby forming an aqueous fluid enriched in ions in the second compartment of the electrochemical cell; and
in step d) cations are released from said first electrode into the aqueous fluid present in the first compartment of the electrochemical cell and anions present in the aqueous fluid of the second compartment are allowed to move into the aqueous fluid of the first compartment of the electrochemical cell, thereby forming a deionized aqueous fluid in the second compartment of the electrochemical cell.

Herein, said first electrode and/or said second electrode preferably comprise an intercalation material selected from the group consisting of Prussian Blue, a Prussian Blue analogue, Na_{0.44}MnO₂, lambda-MnO₂, gamma-MnO₂, delta-MnO₂, Na₂FeP₂O₇, Na₃V₂(PO₄)₃, NaVPO₄F, NaCo_{1/3}Ni_{1/3}Mn_{1/3}PO₄, olivine LiMePO₄, NaTi₂(PO₄)₃ and vanadium oxides, more preferably Prussian Blue or a Prussian Blue analogue, even more preferably nickel hexacyanoferrate or copper hexacyanoferrate. Preferably, said first electrode and said second electrode comprise the same intercalation material.

The invention further relates to a method wherein said first electrode and said second electrode comprise an intercalation material that has an ability to intercalate anions, thereby
in step b) anions are allowed to intercalate into said first electrode and cations present in the aqueous fluid of the first compartment are allowed to move into the aqueous fluid present in the second compartment of the electrochemical cell, thereby forming an aqueous fluid enriched in ions in the second compartment of the electrochemical cell; and
in step d) anions are released from said first electrode into the aqueous fluid present in the first compartment of the electrochemical cell and cations present in the aqueous fluid of the second compartment are allowed to move into the aqueous fluid of the first compartment of the electrochemical cell, thereby forming a deionized aqueous fluid in the second compartment of the electrochemical cell.

A preferred first electrode and/or second electrode is an electrode comprising MXene.

In a particularly preferred method, said first electrode and said second electrode comprise the same intercalation material. In such a method, operation is simplified compared to a method wherein the intercalation material of said first and said second electrode is not the same. In such a method, the properties of the first electrode and the second electrode are essentially identical and as a result, intercalation of ions and (partial) regeneration of the electrodes are also essentially the same.

As the skilled person will understand, in a method according to the invention, said ion-exchange membrane separating said first compartment and said second compartment enables the moving of ions from said first compartment to said second compartment during step b), which ions are of opposite charge as the ions that are intercalated by said first electrode.

Accordingly, if said first electrode comprises an intercalation material that has an ability of intercalation cations, then said ion-exchange membrane is an anion-exchange membrane. However, if said first electrode comprises an intercalation material that has an ability of intercalating anions, then said ion-exchange membrane is a cation-exchange membrane.

Examples of a suitable cation-exchange membrane in a method according to the invention include membranes based on aliphatic or aromatic polymers, such as oly(sulfone)s, poly(arylene ether)s, poly(phenylene)s, poly(styrene)s, polypropylene, poly(phenylene oxide)s, poly(olefin)s, poly(arylene piperidinium), and poly(biphenyl alkylene)s with different anionic groups, such as a sulfonic acid, carboxylate, phosphate, phosphite, arsenite, arsenate and selenite.

Preferably, said ion-exchange membrane is an anion-exchange membrane. Examples of anion-exchange membranes include membranes based on aliphatic or aromatic polymers, such as oly(sulfone)s, poly(arylene ether)s, poly(phenylene)s, poly(styrene)s, polypropylene, poly(phenylene oxide)s, poly(olefin)s, poly(arylene piperidinium), and poly(biphenyl alkylene)s with different cationic groups, such as quaternary ammonium, guanidinium, imidazolium, pyridinium, tertiary sulfonium, spirocyclic quaternary ammonium, phosphonium, phosphatranium, phosphazenium, metal-cation, benzimidazolium, and pyrrolidinium.

Typically, in a method according to the invention, an ion exchange membrane has a diffusion coefficient of between 1-10⁻⁹ and 10-10⁻⁹ m/s, preferably between about 3-10⁻⁹ and 7-10⁻⁹ m/s.

Examples of electrochemical cells comprising a first compartment comprising a first electrode and a second compartment comprising a second electrode, said first and second compartments being separated by an ion-exchange membrane, that are suitable for use in a method according to the invention include cation or anion intercalation desalination cells. A preferred example of such a cell is described in FIG. 1.

In a specific method according to the invention, the electrochemical cell comprises a porous positive electrode, a porous negative electrode and an anion-exchange membrane positioned between the porous positive electrode and the porous negative electrode, wherein the anion-exchange membrane is positioned such that the porous positive electrode is in first physical contact with the membrane and such that the porous negative electrode is in second physical contact with the membrane, wherein the porous positive electrode and the porous negative electrode each comprise a network of conductive material comprising an intercalation material dispersed throughout the conductive material, wherein the porous positive electrode and the porous negative electrode have an intercalation material loading of 1 vol. % to 60 vol. %, and wherein the anion-exchange membrane allows anions to flow therethrough. It is noted that the electrodes are not porous in the conventional sense. Ions are stored in the interstitial pores/sites but the actual porosity of these intercalation electrodes is too small in comparison with carbon to warrant the use of word porous in their description.

Said electrochemical cell further preferably comprises a power supply to supply a current to the electrochemical cell; an inlet for providing an aqueous fluid to the electrochemical cell, the aqueous fluid being directed through the porous positive electrode and through the porous negative electrode; a first outlet for collecting an aqueous fluid enriched in ions; and a second outlet for collecting a deionized aqueous fluid.

Such a preferred electrochemical cell is described in U.S. Pat. No. 11,053,142 and the electrochemical cell is incorporated herein by reference.

### Step a)

In a method according to the invention, an aqueous fluid is directed through the electrochemical cell, thereby allowing contact between said aqueous fluid and said first electrode and second electrode.

Said aqueous fluid typically enters the electrochemical cell via an inlet located near a base of the first electrode and/or second electrode.

Said aqueous fluid may in principle be any aqueous fluid comprising ions, such as sea water, brackish water or a salt solution, such as a sodium chloride (NaCl) solution, a potassium chloride (KCl) solution or a solution comprising a mixture of different salts.

It was found that the method according to the invention is particularly suitable for removing ions from brackish water.

A preferred conductivity of an aqueous fluid, when entering the electrochemical cell, is between about 100 μS·/cm and about 100.000 μS·/cm, preferably between about 500 μS·/cm and about 10.000 μS·/cm, more preferably between about 1000 μS·/cm and about 5000 μS·/cm.

Conductivity of an aqueous fluid can be determined using a conductivity meter, such as the Orion™ Versa Star Pro™ Conductivity Benchtop Meter, commercially available from Thermo Scientific™.

In a method according to the invention, said aqueous fluid may be directed using any suitable method known in the art, for example using mechanical means, such as a mechanical pump.

Preferably, said aqueous fluid is directed in a direction that is essentially parallel to the length of the first and the second electrode. The length of the electrode herein refers to the longest dimension of said electrode. This directing allows the most optimal contact between said electrode and said aqueous fluid, thereby allowing most efficient removal of ions from said aqueous fluid.

Typically, said aqueous solution is directed at a flow rate allowing efficient removal of ions from said aqueous solution. As the skilled person will understand, a suitable flow rate in the method according to the invention depends on the reduction of conductivity of the aqueous feed that is desired. At lower flow rate, typically a higher reduction of conductivity in the aqueous fluid may be achieved, because the residence time of the aqueous fluid in the electrochemical cell is prolonged, provided the conditions in the electrochemical cell are essentially the same. However, the flow rate should not be so low as to cause non-ohmic resistance in the cell as a result of substantial depletion of ions in the aqueous fluid.

Further, as the skilled person will understand, the flow rate is further correlated to the (electric) current applied to the cell. At higher current, a higher reduction of conductivity in the aqueous fluid may be achieved, and thus a higher flow rate may be typically required to avoid occurrence of non-ohmic resistance in the cell, provided the conditions in the electrochemical cell are essentially the same.

Accordingly, the skilled person is capable of selecting an appropriate flow rate, based on the desired reduction of conductivity in the aqueous fluid, and the current applied to the electrical cell, provided that at the selected flow rate, the ratio between the electric current divided by the total weight of the first electrode and the second electrode and the conductivity of the aqueous fluid, when entering the electrochemical cell, is at least 1 to 25 mA·cm/μS·g.

Preferably, in a method according to the invention, the aqueous fluid is directed at a flow rate of between about 2 and about 10 ml/min, more preferably between about 4 and about 8 ml/min. At such flow rates, typically adequate removal of ions was achieved. In case the area of the electrodes and the channels are 20 cm², this flow rate equals a flow rate of between about 0.1 and about 0.5 ml/min·cm², more preferably between about 0.2 and about 0.4 ml/min·cm², as will be evident for a skilled person.

Typically, a reduction of conductivity of an aqueous fluid of between about 100 μS·/cm and about 1000 μS·/cm, preferably between about 200 μS·/cm and about 900 μS·/cm, more preferably between about 300 μS·/cm and about 800 μS·/cm, in particular bout about 400 μS·/cm and about 600 μS·/cm is achieved in a single cycle using a method according to the invention.

In the method according to the invention, the flow rate is typically at least essentially constant.

### Step b)

In a method according to the invention, a current is applied to the electrochemical cell, thereby allowing intercalation of cations or anions present in the aqueous fluid into the intercalation material of the first electrode, and allowing removal of cations or anions from the aqueous fluid present in the first compartment, thereby forming a deionized aqueous fluid in the first compartment of the electrochemical cell.

The skilled person is capable of selecting an appropriate current to be applied to the electrochemical cell in step b). As the skilled person understands, the higher the current applied, the more ions are extracted or intercalated from the aqueous fluid into the first electrode and second electrode, per unit of time. This leads to a higher reduction of conductivity in the aqueous fluid present in the electrochemical cell.

Accordingly, if a high reduction of conductivity in the aqueous fluid is desired, typically a higher current may be selected, provided that the ratio between the electric current divided by the total weight of the first electrode and the second electrode and the conductivity of the aqueous fluid, when entering the electrochemical cell, is at least 1 to 25 mA·cm/μS·g.

The current that is applied during step b) in the method according to the invention preferably ranges between 5 mA/g and 75 mA/g, preferably between 25 mA/g and 55 mA/g. Herein the weight in grams refers to the total weight of the first and second electrode.

The skilled person knows how to apply a current to an electrochemical cell. Typically, the total weight of the electrodes is determined during construction of the electrochemical cell as described herein above. The current normalized by the electrode weight is divided by the weight of the electrodes, to give an absolute value of the current, which may be entered into a suitable power supply, during step b) of a method according to the invention.

As the skilled person will appreciate that the amount of time the current is applied during step b) is dependent on the capacity of the first electrode and the second electrode, the current and the reduction of conductivity of ions from the aqueous fluid that is required.

At high capacity of the electrodes, said current may be applied for a longer amount of time, until full capacity of at least one of the electrodes is reached. As the skilled person understands, herein the capacity of the electrochemical cell is limited by the capacity of the electrode that has the lowest capacity.

Furthermore, as the skilled person will realize, if only a small reduction in conductivity of the aqueous fluid is required, the time the current is applied in step b) may be lower. In this case, it is possible that the full capacity of the electrode having the lowest capacity has not yet been reached, before the current is reverted in step d) to at least partly regenerate the electrodes.

The skilled person is capable of selecting an appropriate amount of time the current is applied to the electrochemical cell in step b), also referred to in the art as the ‘half cycle time’. The half cycle time may be calculated by dividing the capacity of the electrode having the lowest capacity (in mAh/g) by the current (in mA/g). This gives the half cycle time, using full capacity of the electrodes.

Accordingly, in a method according to the invention, a half cycle time, not exceeding this calculated value, is typically selected, depending on the reduction in conductivity of the aqueous fluid that is desired, and percentage of capacity of the electrodes that may be used. Important herein, is that the half cycle time is selected such that the average voltage in the electrochemical cell during step b) and the average voltage in the electrochemical cell during step d) does not exceed 0.5 V, more preferably does not exceed 0.4 V, in particular does not exceed 0.3 V.

Typical half cycle times range between 1 and 60 minutes, more preferably between 1.5 and 45 minutes, between 2 and 30 minutes, between 2.5 and 25 minutes, between 3 and 20 minutes, between 3.5 and 15 minutes, between 4 and 10 minutes, most preferably between 5 and 8 minutes.

### Step c)

Subsequently or simultaneously with step b), said deionized aqueous fluid is collected from the electrochemical cell as described in step c). This may be achieved using any suitable method known in the art.

Accordingly, said deionized aqueous fluid may be collected from the electrochemical cell by actively withdrawing said deionized aqueous fluid from the electrochemical cell, for example using mechanical means such as a mechanical pump.

Alternatively or additionally, said deionized aqueous fluid may be passively collected, as a result of a flow present in the electrochemical cell.

Said aqueous fluid typically collected from the electrochemical cell via an outlet located near a base of the first electrode and/or second electrode.

Said deionized aqueous fluid may be collected in a suitable container, or in a suitable conduit, said conduit being connected to an inlet of a second electrochemical cell, to allow further removal of ions from said aqueous fluid.

### Step d)

In a method according to the invention, after applying a current as described in step b), the current is reverted, thereby releasing cations and anions into the first compartment of the electrochemical cell, thereby at least partly regenerating said first electrode and said second electrode, and forming an aqueous fluid enriched in ions into the first compartment of the electrochemical cell.

With ‘reverting the current’ is meant herein, that the direction of the current in the electrochemical cell is changed. Thus, if in step b) the current moves from the first electrode to the second electrode, in step d) the current moves from the second electrode to the first electrode. This may be achieved by applying a negative absolute value of the current to the electrochemical cell.

The skilled person is capable of selecting an appropriate current to be applied to the electrochemical cell in step d).

As the skilled person understands and as described herein above for step b), the higher the current applied, the more ions are released into the aqueous solution into the first electrode and second electrode, per unit of time. This leads to faster regeneration of the first electrode and the second electrode of the electrochemical cell. Accordingly, if fast regeneration of ions from an aqueous fluid is desired, typically a higher current may be selected, provided that the difference in average voltage in the electrochemical cell during step b) and the average voltage in the electrochemical cell during step d) is as low as possible, preferably less than 0.5 V, less than 0.4 V, in particular less than 0.3 V to avoid substantial degeneration of the first electrode.

The current that is applied during step d) in the method according to the invention preferably ranges between −5 mA/g and −75 mA/g, preferably between −25 mA/g and −55 mA/g, wherein the weight in grams refers to the total weight of the first and second electrode. The skilled person knows how to apply a current, as described herein above for step b).

Preferably, the current that is applied in step d) is essentially the same as the current applied during step b), albeit in opposite direction.

As the skilled person will appreciate, the amount of time the current is applied during step d) is dependent on the current that is being applied and the % regeneration of the first electrode and second electrode that is desired.

If a high % regeneration of the first and the second electrodes is desired, said current may be applied for a longer amount of time, for example until the electrodes are essentially completely regenerated.

Furthermore, as the skilled person will realize, if only a small % regeneration of the first and the second electrodes is desired, the time the current is applied in step d) may be lower.

Preferably, said first and/or said second electrodes are regenerated until at least 50% of their original capacity, more preferably at least 60%, at least 70%, at least 80%, at least 90%, most preferably until 100% of the original capacity is retained.

The skilled person is capable of selecting an appropriate half cycle time for step d). The half cycle time may be calculated by dividing the capacity of the electrodes that is filled with ions (in mAh/g) by the current (in mA/g). This gives the half cycle time, allowing full regeneration of the electrodes.

Accordingly, in a method according to the invention, a half cycle time not exceeding this calculated value is typically selected, depending on % regeneration of electrodes that is desired. Important herein, is that the half cycle time is selected such that the average voltage in the electrochemical cell during step b) and the average voltage in the electrochemical cell during step d) does not exceed 0.5 V, more preferably does not exceed 0.4 V, in particular does not exceed 0.3 V.

Typical half cycle times range between 1 and 60 minutes, more preferably between 1.5 and 45 minutes, between 2 and 30 minutes, between 2.5 and 25 minutes, between 3 and 20 minutes, between 3.5 and 15 minutes, between 4 and 10 minutes, most preferably between 5 and 8 minutes.

Preferably, the half cycle time during step d) is essentially the same as the half cycle time of step b).

During step d) an aqueous fluid is produced that is enriched in ions. The aqueous fluid produced during step d) is typically collected from the electrochemical cell. This may be achieved in the same manner as described herein above for step c).

Typically, said aqueous fluid enriched in ions is discarded from the cell.

Alternatively, said aqueous fluid enriched in ions may be subjected to one or more treatment steps to recover ions present in the aqueous fluid. This may be achieved, for example by subjecting the aqueous fluid to a step of evaporation, to remove water.

After at least partly regenerating said first and said second electrodes, steps b) and d) are preferably repeated, more preferably at least 100 times, more preferably at least 500 times, even more preferably at least 1000 times.

The invention is now demonstrated by the following Examples.

### EXAMPLES

### Example 1

### Experimental Section

### NiHCF Synthesis and Electrode Preparation

NiHCF powder was prepared by a co-precipitation method. A 200 mL 24 mM NiCl2·6H₂O (Alfa Aesar) solution and a 200 mL 12 mM Na4Fe[(CN)6]·10H₂O solution (Sigma Aldrich) were drop-wise added to 200 mL milliQ water under stirring at 600 rpm. The reaction mixture was stirred for ≈12 h. The precipitate formed was washed three times with MilliQ water using a vacuum filtration unit and dried overnight in a vacuum oven at 60° C. The dried NiHCF powder was used as an active material in the free-standing electrodes. These electrodes contained conductive carbon black (Cabot) and poly-tetrafluroethylene (PTFE) (Sigma Aldrich). The NiHCF and the conductive carbon were milled together using a Planetary Ball Mill PM 200 from Retsch (Haan, Germany). The fine NiHCF-carbon blend was mixed with the 60% (by weight) PTFE dispersion and a solvent (ethanol). The slurry contained NiHCF, carbon black and the PTFE in a ratio of 8:1:1 by weight. The slurry was kneaded until most of the solvent evaporated. The remaining electrode mass, a wet dough, was rolled into 200 μm sheets with stainless steel rollers in a rolling machine (MTI Corp., Richmond CA) at room temperature. The electrodes were then cut into rectangles of 10 cm×2 cm, dried in an oven at 60° C. for 2 h and weighed. The weight of the combined electrodes was 0.68 gram.

### Cell Assembly

One fully intercalated and one fully deintercalated electrode were assembled in a desalination cell as illustrated before with spacer channels, an anion exchange membrane (AMX, Neosepta), graphite current collectors and PVC end plates to sandwich the arrangement together. After the assembly, the cell was short-circuited for 1 h. This step before starting the desalination experiment was performed to equalize the ion content in the two assembled electrodes. The two compartments were fed by a 10 L, 20 mM NaCl solution via a peristaltic pump (Masterflex). The concentration of the feed was measured at the outlet by placing a conductivity probe, connected to a conductivity meter (Orion Versa Star, Thermo Fisher), in the path of the flow. The cell was electronically connected to a Potentiostat (Ivium Technologies) that served as a power source and measurement device.

Once equilibrated (when current went <1 mA), desalination of the feed was started. The conditions were:
Applied current (I): 13, 25, 35, and 45 mA (≈19.1, 36.7, 51.5, and 66 mA/g both_electrodes)
Half cycle time (tHCT): 4-7 minutes: Total cycle time: 8-14 minutes
Voltage window: ±1 V
Feed concentration—4 mM and 20 mM, corresponding to a conductivity of 445,6 and 2228 uS/cm, respectively based on a calibrated conductivity meter in which conductivity in uS/cm is 1114 times the concentration in mM.
Flowrate (Q): 6 or 7 mL/min
1410 cycles, interrupted regularly to change the conditions and data storage
Feed was recycled

The sequence of cycles and conditions for these cycles are provided in Table 1.

TABLE 1
Conditions of the desalination operations performed with a symmetric CDI cell containing two identical NiHCF electrodes.

| | | | | current/ | | | | | | | |
|---|---|---|---|---|---|---|---|---|---|---|---|
| | | | Electrode | electrode | | | Feed | Conductivity | Ratio | | Ratio |
| | | Current | weight | weight | Cycle | Total | concentration | Measured | (5)/(3) | Conductivity | (5)/(3) |
| | | (1) | (2) | (3) = (1)/(2) | time | Time | (4) | (5) = (4)*1114 | (mA*cm)/ | Estimated | (mA*cm)/ |
| # | cycles | mA | g | mA/g | min | min | mM | μS/cm | (μS*g) | MicroS/cm | (μS*g) |
| 1 | 500 | 25 | 0.68 | 36.76470588 | 8 | 4000 | 20 | 2228 | 60.60 | 2400 | 65.28 |
| 501 | 512 | 25 | 0.68 | 36.76470588 | 14 | 168 | 20 | 2228 | 60.60 | 2400 | 65.28 |
| 513 | 763 | 35 | 0.68 | 51.47058824 | 10 | 2500 | 20 | 2228 | 43.29 | 2400 | 46.63 |
| 764 | 770 | 25 | 0.68 | 36.76470588 | 10 | 55 | 20 | 2228 | 60.60 | 2400 | 65.28 |
| 770 | 820 | 25 | 0.68 | 36.76470588 | 8 | 400 | 20 | 2228 | 60.60 | 2400 | 65.28 |
| 821 | 960 | 45 | 0.68 | 66.17647059 | 9.6 | 1344 | 20 | 2228 | 33.67 | 2400 | 36.27 |
| 961 | 1005 | 25 | 0.68 | 36.76470588 | 8 | 360 | 20 | 2228 | 60.60 | 2400 | 65.28 |
| 1006 | 1106 | 45 | 0.68 | 66.17647059 | 8 | 800 | 20 | 2228 | 33.67 | 2400 | 36.27 |
| 1107 | 1157 | 25 | 0.68 | 36.76470588 | 8 | 400 | 20 | 2228 | 60.60 | 2400 | 65.28 |
| 1158 | 1248 | 13 | 0.68 | 19.11764706 | 8 | 720 | 4 | 445.6 | 23.31 | 480 | 25.11 |
| 1249 | 1309 | 13 | 0.68 | 19.11764706 | 8 | 360 | 4 | 445.6 | 23.31 | 480 | 25.11 |
| 1310 | 1410 | 25 | 0.68 | 36.76470588 | 8 | 800 | 20 | 2228 | 60.60 | 2400 | 65.28 |
| total | 1410 | | | operation | | 11907 | mins | | | | |
| | | | | | | 198.45 | hrs | | | | |
| | | | | | | 8.26875 | days | | | | |

### Results

The sample current-voltage (IV) and concentration data for different cycles are provided in FIG. 2A, B. The difference between the ECharge datapoints and the EDischarge datapoints is the ΔE. This is the parameter of interest in the study as a change in it will indicate a change in the energy consumption of the cell. As the electrodes degrade and the insides of the cell develop fouling, the ΔE, will increase. This implies that the Echarge and EDischarge will change relative to each other. Therefore, ΔE becomes one of the direct indicator of electrode/cell degradation. As is shown in FIG. 2, the ΔE remains constant during the first 34 cycles.

FIG. 3 provides the concentration of the two effluent channels in μS/cm, recorded during the first 1-34 cycles.

FIG. 4 shows the IV data for the final 100 cycles of operation, after the cell had been operated at 13, 25, 35, and 45 mA and at 4 and 20 mM, as summarized in Table 1.

The <Echarge>, <EDischarge>, and ΔE values calculated from the cell voltages recorded during the last 100 cycles are graphically depicted in FIG. 5. Furthermore, the concentration of the effluents during the last 100 cycles is depicted in FIG. 6. The ΔE values of the cell calculated at different stages of operation of the cell, reflecting the status of the electrode is depicted in FIG. 7.

From these data, it can be concluded that:

1. The IV profile changed over the course of 1400 cycles. However the change in concentration remained similar. The difference seen in FIGS. 3 and 6 is merely due to the varying Q. This implies that the capacity of the electrode to adsorb cations remained largely unchanged over a total of 1400 cycles. Furthermore, the shape of the concentration profile remained highly unchanged, indicating that the transport of ions from the spacer to the electrode remained unaffected by any new transport limitation, brought upon by an ageing electrode and, potentially fouling spacer and membrane, since the cell remained closed for more than 2 weeks.

2. The IV profile changed after 1400 cycles, as it can be discerned on comparing IV profiles in FIGS. 1 and 4. This implies that to do the same amount of adsorption/desorption, the electrodes had to work at higher voltages. This may indicate a degradation in electrode quality. To quantify this degradation, the ΔE values obtained for at different points of time during the overall desalination, for 25 mA and 4 minutes half cycle time, are provided in FIG. 7, wherein the lines indicate the ΔE values for the cycles: 1-35, 350-500, 1100-1150, and 1310-1410. It must be noted that from cycle 35 to cycle 1150, the ΔE, on average, increased by 60%. This means, when the cell was operated at 25, 35 and 45 mA applied current, at varying half cycles times, to desalinate a 20 mM feed, the ΔE increased by 60%. However, after the cell was cycled at 13 mA to desalinate a feed of 4 mM, the ΔE increased further (from the level of cycle 1150) by 42%. This sharp increase means that the desalination of a lower concentration feed solution accelerated the electrode degradation. This could be understood from FIG. 8, which illustrates the IV profiles obtained during the desalination of a 4 mM feed at 13 mA.

It is clear from FIG. 7 that the average charge and discharge voltages during the final cycles are high in comparison to those seen during desalination of 20 mM feed (higher by ≈3 times). The sharp increase in the ΔE from beyond cycle 1150 may indicate that the degradation of the electrodes appears to accelerate due to operation at higher voltages.

The overall conclusion is that, in order to maintain the ΔE and therefore, the quality of the electrodes, their operation must be restricted to as low a voltage as possible. Ways in which this can be achieved are:
1. Operation at low currents;
2. Reduction in cycle time;
3. Increase in feed concentration;
4. Operation at increased flow rates.

1. A method for removing ions from an aqueous fluid in an electrochemical cell,
said electrochemical cell comprising a first compartment comprising a first electrode, said first electrode comprising a conductive material and an intercalation material, wherein said electrochemical cell further comprises a second electrode, and wherein said electrochemical cell is configured to allow propagation of a current,
the method comprising:
a) directing an aqueous fluid through the electrochemical cell, thereby allowing contact between said aqueous fluid and said first electrode and second electrode;
b) applying a current to the electrochemical cell, thereby
allowing intercalation of cations present in the aqueous fluid into the intercalation material of the first electrode, and allowing removal of anions from the aqueous fluid present in the first compartment; or
allowing intercalation of anions present in the aqueous fluid into the intercalation material of the first electrode, and allowing removal of cations from the aqueous fluid present in the first compartment;
thereby forming a deionized aqueous fluid in the first compartment of the electrochemical cell;
c) collecting the deionized aqueous fluid from the first compartment of the electrochemical cell;
d) reverting the current, thereby releasing cations and anions into the first compartment of the electrochemical cell, thereby at least partly regenerating said first electrode and said second electrode, and forming an aqueous fluid enriched in ions into the first compartment of the electrochemical cell;
wherein the voltage in the electrochemical cell, is between −1.23 V and 1.23 V and wherein the ratio between the electric current divided by the total weight of the first electrode and the second electrode and the conductivity of the aqueous fluid, when entering the electrochemical cell, is at least 1 to 25 mA·cm/S·g and
wherein the difference between the average voltage in the electrochemical cell during step b) and the average voltage in the electrochemical cell during step d) is between 0.1 and 0.5 V.

2. The method according to claim 1, wherein said second electrode has an ability to remove ions from an aqueous fluid, which ions are of opposite charge as the ions intercalated by said first electrode,
wherein in step b) said removal comprises insertion of said cations or anions into said second electrode; and
wherein in step d) said releasing comprises either release of cations from said first electrode into the first compartment of the electrochemical cell and release of anions from said second electrode into the first compartment of the electrochemical cell; or release of anions from said first electrode into the first compartment of the electrochemical cell and release of cations from said second electrode into the first compartment of the electrochemical cell.

3. The method according to claim 1, wherein said electrochemical cell further comprises a second compartment comprising said second electrode, said first and second compartments being separated by an ion-exchange membrane,
wherein in step b) said removal comprises allowing cations or anions present in the aqueous fluid in the first compartment to move into the aqueous fluid present in the second compartment of the electrochemical cell; and
wherein in step d) said releasing comprises either release of cations from said first electrode into the first compartment of the electrochemical cell and allowing anions present in the aqueous fluid of the second compartment to move into the aqueous fluid of the first compartment of the electrochemical cell; or release of anions from said first electrode into the first compartment of the electrochemical cell and allowing cations present in the aqueous fluid of the second compartment to move into the aqueous fluid of the first compartment of the electrochemical cell.

4. The method according to claim 3, wherein said first electrode and said second electrode comprises an intercalation material that has an ability to intercalate cations, preferably wherein the intercalation material of said first electrode and said second electrode is the same, wherein,
in step b) cations are allowed to intercalate into said first electrode and anions present in the aqueous fluid of the first compartment are allowed to move into the aqueous fluid present in the second compartment of the electrochemical cell, thereby forming an aqueous fluid enriched in ions in the second compartment of the electrochemical cell; and
in step d) cations are released from said first electrode into the aqueous fluid present in the first compartment of the electrochemical cell and anions present in the aqueous fluid of the second compartment are allowed to move into the aqueous fluid of the first compartment of the electrochemical cell, thereby forming a deionized aqueous fluid in the second compartment of the electrochemical cell.

5. The method according to claim 1, wherein steps a) and c) are performed simultaneously with steps b) and d).

6. The method according to claim 1, wherein the ratio between the electric current divided by the total weight of the first electrode and the second electrode and the conductivity of the aqueous fluid, when entering the electrochemical cell, is between 1 to 30 and 1 to 75 mA·cm/S·g.

7. The method according to claim 1, wherein in step b) the current is applied for between 1 and 60 minutes, preferably between 3 and 30 minutes, more preferably between 4 and 8 minutes and/or wherein in step d) the current is reverted for between 1 and 30 minutes, preferably between 3 and 30 minutes, more preferably between 4 and 8 minutes.

8. The method according to claim 1, wherein the difference between the average voltage in the electrochemical cell during step b) and the average voltage in the electrochemical cell during step d) is between between 0.2 and 0.4 V, more preferably around 0.3 V.

9. The method according to claim 1, wherein in step b) the current is between 5 mA/g and 75 mA/g, preferably between 25 mA/g and 55 mA/g and/or wherein in step d) the current is between −5 mA/g and −75 mA/g, preferably between −25 mA/g and −55 mA/g.

10. The method according to claim 1, wherein the concentration of ions in the aqueous fluid, when entering the electrochemical cell, is between about 100 S·/cm and about 100.000 S·/cm, preferably between about 500 S·/cm and about 10.000 S·/cm, more preferably between about 1000 S·/cm and about 5000 S·/cm.

11. The method according to claim 1, wherein the aqueous fluid is directed at a flow rate of between about 3 and about 10 ml/min-cm², preferably between about 4 and about 8 ml/min-cm².

12. The method according to claim 1, wherein the intercalation material is selected from Prussian Blue, a Prussian Blue analogue, Na_{0.44}MnO₂, lambda-MnO₂, gamma-MnO₂, delta-MnO₂, Na₂FeP₂O₇, Na₃V₂(PO₄)₃, NaVPO₄F, NaCo_{1/3}Ni_{1/3}Mn_{1/3}PO₄, olivine LiMePO₄, NaTi₂(PO₄)₃ and vanadium oxides, preferably wherein the intercalation material comprises a Prussian Blue Analogue material, more preferably nickel hexacyanoferrate or copper hexacyanoferrate.

13. The method according to claim 1,
wherein at least one electrode, preferably both electrodes, comprises
70-90 wt. % of an intercalation material, preferably nickel cyanoferrate;
0-10 wt. % of a binder; and
5-20 wt. % of a conduction material, preferably carbon, with the proviso that the total of intercalation material, binder and conduction material is between 95 wt. % and 100 wt. %, more preferably between 97 wt. % and 100 wt. %, even more preferably between 99 wt. % and 100 wt. %.

14. The method according to claim 1, wherein steps b) and d) are repeated, preferably at least 100 times, more preferably at least 500 times, even more preferably at least 1000 times.
